(19) United States
(12) Patent Application Publication
(10) Pub. No.: US 2013/0024112 A1
(43) Pub. Date: Jan. 24, 2013

(54) SYSTEM AND METHOD FOR GENERATING RECOMMENDED DRIVING ROUTES FOR AN ELECTRIC VEHICLE

(71) Applicant: Edward D. Tate, JR., Grand Blanc, MI (US)

(72) Inventor: Edward D. Tate, JR., Grand Blanc, MI (US)

(73) Assignee: GM GLOBAL TECHNOLOGY OPERATIONS LLC, Detroit, MI (US)

(21) Appl. No.: 13/184,751

(22) Filed: Jul. 18, 2011

(51) Int. Cl. G01C 21/34; G06F 7/00

(52) U.S. Cl. 701/439; 701/467

(57) ABSTRACT

A navigation system for a vehicle includes a display device and host machine. The host machine communicates with a map database containing information describing a geocoded road network. The network includes nodes each describing a point within the network, with some nodes describing charging waypoints. The host machine executes a method, including recording a destination, determining a remaining state of charge (SOC) of a battery, and calculating a remaining electric vehicle (EV) range of the vehicle using the remaining SOC for every node. The host machine generates a first recommended EV travel route to the destination using a shortest distance or travel time approach when the destination lies within the remaining EV range. The host machine generates a second recommended EV travel route to the destination through a charging waypoint(s) when the destination lies outside of the remaining EV range. The EV route is displayed via the display device.

### TECHNICAL FIELD

The present disclosure relates to generating a recommended travel route within a vehicle having an electric powertrain.

### BACKGROUND

Vehicle navigation systems are networked computer devices which use global positioning data to accurately determine the position of a device or of a vehicle on a geocoded map. A server or host machine typically calculates a recommended travel route through a road network using a shortest distance or quickest drive time algorithm, and using associated geospatial, topographical, and road network information. A navigation system may also provide turn-by-turn directions to a destination in the form of text and/or speech, with corresponding route traces displayed on a map. However, conventional navigation systems may perform in a less than optimal manner when used in conjunction with emerging battery electric and extended-range electric vehicle designs having an electric powertrain.

### SUMMARY

A navigation system and method of using the same are disclosed herein for use in an electric vehicle, e.g., a battery electric vehicle (BEV), an extended-range electric vehicle (EREV), or any other vehicle having an electric powertrain. The present navigation system calculates and displays a recommended electric vehicle (EV) travel route, i.e., a route travelled solely using electric power, in part by using a directed graph (digraph) approach. That is, a digraph is used to evaluate all of the possible ways of traveling to a destination within a road network. The recommended EV travel route passes through the road network to the destination, with automatic modification of the travel route to charging stations along the way, i.e., charging waypoints, when the vehicle cannot reach its destination on remaining battery power.

That is, the present navigation system creates the road network and populates the same with all known charging waypoints. These charging waypoints are identified as nodes within the road network, as are the various road intersections and other demarcated points of interest within the road network. The various possible ways of moving through the road network with one or more battery charging events are then generated as a list of or vertices or nodes. One node in the map is always the present location of the vehicle within the road network.

For each additional node on the map, a host machine of the navigation system generates a list of “next-possible” nodes, that is, nodes which are reachable by the vehicle under existing battery power from its present position node. Existing routing algorithms and databases may be reused to automatically insert more charging waypoints as needed as the vehicle travels through the road network. This may be accomplished by modifying the representation of the vertices/nodes of the map to represent the sequence of charging events as they occur as the vehicle negotiates its way along the travel route.

Additionally, a calculation is performed by the host machine for each evaluated node to determine the remaining EV range of the vehicle. The host machine restricts the list of next-considered node(s), i.e., the nodes evaluated in the next iteration, to only include those nodes which can be reached in the initial range, and with any scheduled charging stops as needed. The routes thus largely eliminate EV range anxiety, a term used to describe the concern of depleting the battery prior to arriving at a charging waypoint or the final trip destination.

If a recommended travel route is available which does not require a charging event, this route may be selected by the host machine using, for instance, existing shortest distance or fastest drive time-routing algorithms, even if charging waypoints happen to be available along the travel route. Thus, the opportunity cost of charging is always considered, with a charging event processed as a new range constraint. The map is thus “layered” and evolves as the vehicle moves through the road network, with memory retained by the host machine of all previous charging events and map layers, and with a newly generated map being associated with each new charging waypoint.

In particular, a navigation system is disclosed for a vehicle having a battery and a traction motor. The system includes a display device, as well as a host machine in communication with a map database. Road network information from the database includes nodes, with each node describing a point within the road network. At least some of the nodes describe charging waypoints.

The host machine is configured for recording a trip destination, determining a remaining state of charge (SOC) of the battery, and calculating a remaining electric vehicle (EV) range of the vehicle from each node using the remaining SOC. The host machine also generates a first recommended electric-only (EV) travel route to the destination using one of a shortest distance and a shortest travel time approach when the destination lies within the remaining EV range from a node describing the present location of the vehicle, and generates a second recommended EV travel route to the destination through one or more charging waypoints when the destination lies outside of the remaining EV range. The route is displayed via the display device.

A vehicle is also disclosed herein having a traction motor, battery, and the navigation system essentially as noted above.

A method for using the navigation system includes receiving a trip destination using a display device of the system, recording the trip destination using a host machine in communication with the display device, and determining a remaining state of charge (SOC) of the battery using the host machine. The method also includes calculating a remaining electric vehicle (EV) range of the vehicle as a function of the remaining SOC for every node of the plurality of nodes, and generating a first recommended electric-only (EV) travel route to the destination using one of a shortest distance and a shortest travel time approach when the destination lies within the remaining EV range from a node describing the present location of the vehicle. A second recommended EV travel route is generated to the destination through the charging waypoint(s) when the destination lies outside of the remaining EV range. The method also includes displaying one of the first and second recommended EV travel routes via the display device.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having an electric powertrain and a navigation system as disclosed herein.

FIG. 2 is a schematic illustration of a map generated by the present navigation system.

FIG. 3 is a flow chart describing an example method for using the navigation system of FIG. 1 to generate a recommended electric vehicle (EV) travel route.

FIG. 4 is a flow chart describing another example method for generating a recommended EV travel route.

FIG. 5 is a flow chart describing an example method for identifying neighbor nodes in a road network in a recommended EV travel route.

### DESCRIPTION

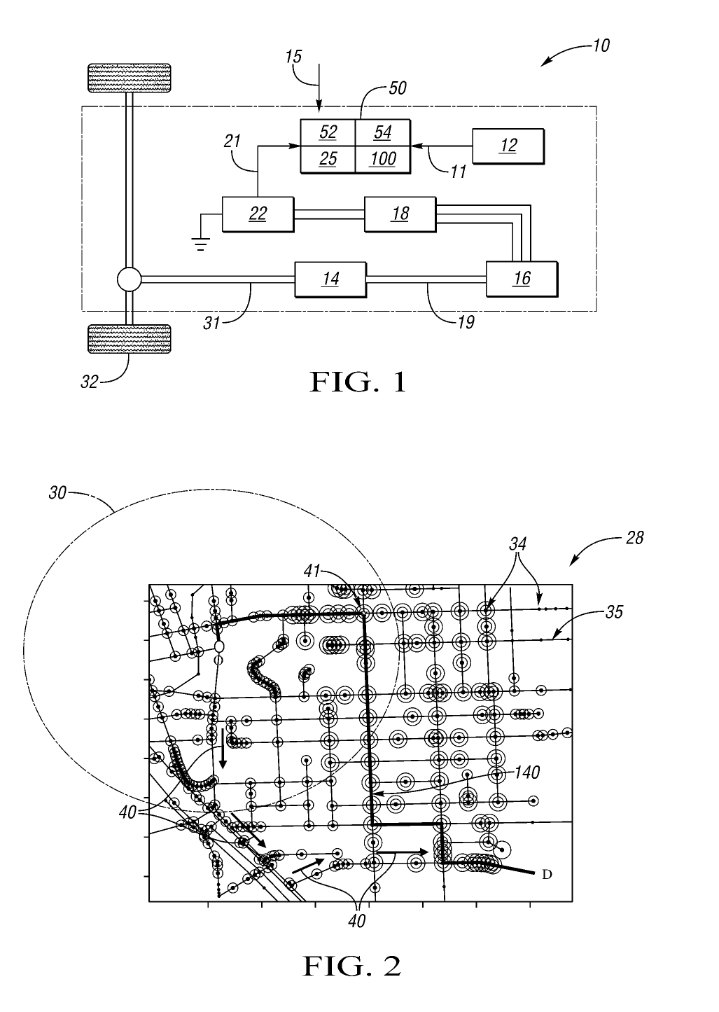

Referring to the drawings, wherein like reference numbers correspond to like or similar components throughout the several figures, an example vehicle 10 is shown schematically in FIG. 1. The vehicle 10 includes a navigation system 50, which may be configured as a host machine or a server mounted within the vehicle 10, or alternatively as a handheld device transported by a user seated in the vehicle 10. In various embodiment, the vehicle 10 may be a battery electric vehicle (BEV) or an extended-range electric vehicle (EREV) as described below, or any other vehicle having an electric powertrain. As is understood in the art, such a vehicle is powered solely using electrical energy in what is referred to as electric vehicle or EV mode.

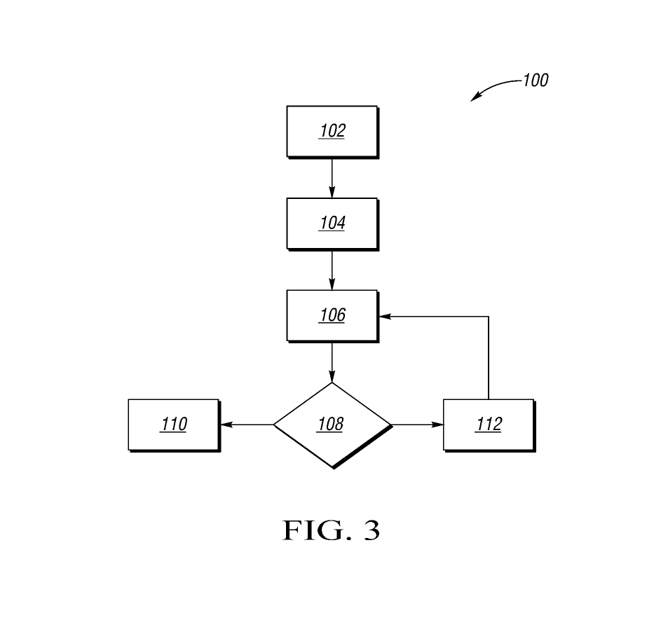

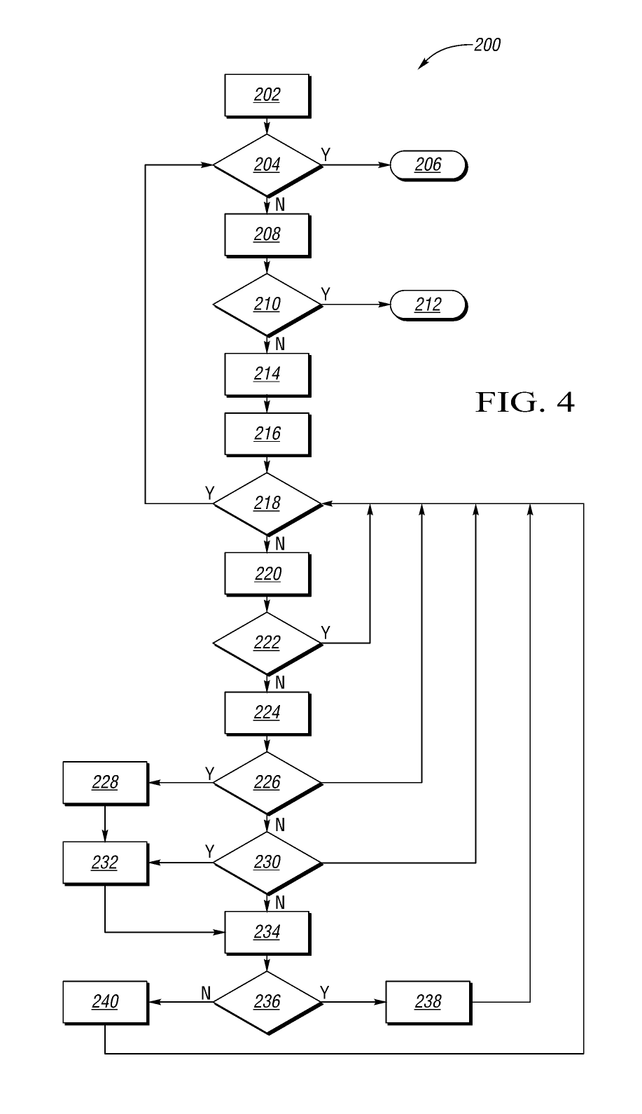

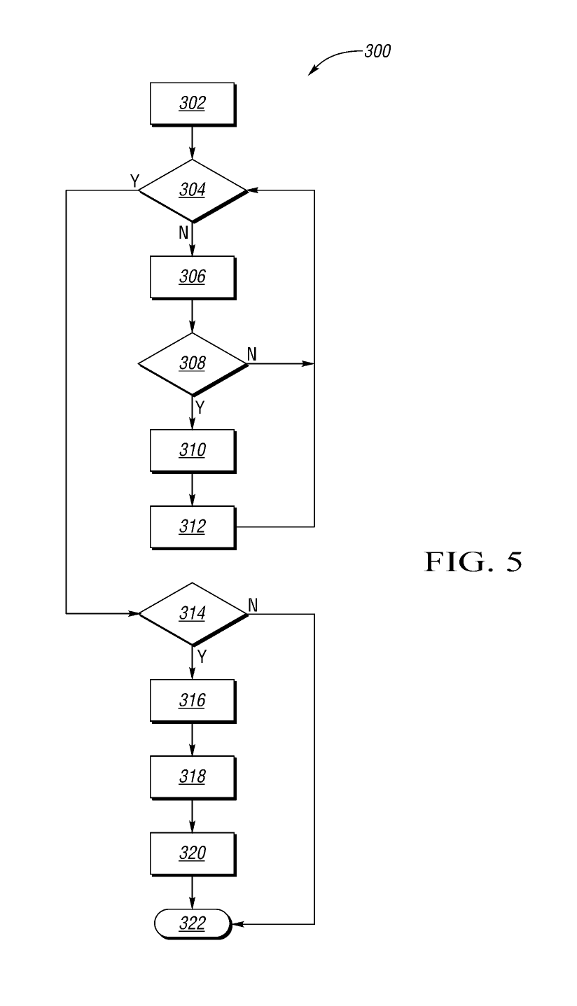

The navigation system 50 automatically generates and displays a geocoded map with a recommended EV travel route using the present method 100, which may be embodied as a set of process instructions or computer code recorded in tangible/non-transitory memory 25. The navigation system 50 executes method 100 from memory 25 to generate the recommended EV travel route from a point of origin to a point of destination through a road network on the map, as explained below with reference to FIGS. 2 and 3. Specific example embodiments are also presented via the methods 200 and 300 of respective FIGS. 4 and 5. The route includes, if needed, automatically scheduled stops for electrical charging at various nodes of the map. An example embodiment of method 100 is described below with reference to FIG. 3.

The navigation system 50 may be embodied as a host machine, whether fixed or portable, as noted above. For example, the navigation system 50 may include one or multiple digital computers or data processing devices, each having one or more microprocessors or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, and any required input/output (I/O) circuitry and devices, as well as signal conditioning and buffering electronics. While shown as a single device in FIG. 1 for simplicity and clarity, the various elements of the navigation system 50 may be distributed over as many different hardware and software components as are required.

In the non-limiting illustrative embodiment shown in FIG. 1, the vehicle 10 includes an electric traction motor 16 that provides motor torque to a transmission 14 via a motor shaft 19, and an energy storage system or battery 22, e.g., a relatively high-voltage, multi-cell rechargeable battery module. A power inverter module (PIM) 18 may be electrically connected between the battery 22 and the traction motor 16 via a high-voltage AC bus, and used to convert AC power from the motor to DC power for storage in the battery 22 and vice versa.

A high-voltage DC bus may be electrically connected between the PIM 18 and the battery 22. A DC-DC power converter (not shown) may also be used as needed to increase or decrease the level of DC power to a level suitable for use by various DC-powered vehicle systems. When it is alternatively configured as an EREV, the vehicle 10 would include an internal combustion engine (not shown), which selectively generates engine torque to charge the battery 22. The traction motor 16 is connected to the transmission 14, e.g., one or more gear sets, clutches, etc., and to a set of drive wheels 32 via an output shaft 31. In other embodiments, the traction motor 16 or multiple traction motors 16 may be directly connected to one or more of the drive wheels 32.

Still referring to FIG. 1, the navigation system 50 is in communication with a geospatial database 12, which may be located aboard the vehicle 10 as shown or remotely accessed via telemetry or network feed, e.g., as a software program. From the geospatial database 12, the navigation system 50 can receive geospatial information (arrow 11) for use in generating the map. As used herein, the term “geospatial database” refers to a geographic information system containing geospatial data of multiple contiguous locations.

The navigation system 50 displays a recommended EV travel route to a user via a display screen 52. The display screen 52 may graphically or visually display the recommended EV travel route via a graphical route/map trace and/or text-based driving directions, and/or may be further configured with an audio speaker 54 that broadcasts turn-by-turn driving directions as audible speech. Additional input data (arrow 15) to the navigation system 50 may include a detected or entered route origin and a recorded route destination, which may be entered prior to commencing the trip via the display screen 52 when the display screen 52 is configured as an optional touch screen device, or using any other suitable input device.

The navigation system 50 uses a directed graph (digraph) to generate the map shown in FIG. 2 and discussed below. As is understood in the art, a digraph (G)=(V, E), where the set (V) represents the vertices or nodes of the graph (G), and the set (E) represents the ordered pair of vertices, i.e., the directed edges of the map. The directed edges (E) in turn define the existence of possible travel between nodes in the graph (G). A routing function (F) is then defined by the navigation system 50 for the routing information set (O, D, V, E, C), wherein C represents nodes corresponding to known charging waypoints.

Referring to FIG. 2 in conjunction with the flow chart shown in FIG. 3, the navigation system 50 of FIG. 1 generates a map 28 of a road network having various roads 35, with the map 28 demarcated by a plurality of nodes 34. The nodes 34 are typically points marking the intersections of the roads 35 and/or points along stretches of roads 35. A node identifier is assigned to each node 34 in the map 28. The various possible ways of moving through the road network may be generated as a list of nodes 34, including a node 34 corresponding to the present location of the vehicle 10 and all next-possible nodes reachable from the present position.

In FIG. 2, a single circle indicates a node that was searched starting from the point of origin (O). A double circle indicates that this node was searched starting from a charging point, e.g., point 41. Only two layers of searching are shown for clarity, however the process can continue with a new search of all nodes 34 at each charging waypoint.

At step 102 of FIG. 3, a user of the navigation system 50 shown in FIG. 1 first selects a route destination (point D). Step 102 may be accomplished via the display screen 52 of FIG. 1, e.g., data entry via a touch screen, with the system 50 of FIG. 1 recording the entered value in memory 25. Route origin (point O) may also be entered, or it may be automatically detected, for instance using GPS.

At step 104, the navigation system 50 of FIG. 1 obtains the remaining EV range of the vehicle 10 from its present point, such as by measuring the present state of charge (SOC) (arrow 21) of the battery 22 of FIG. 1 and then calculating the remaining EV range from this value. The present/remaining SOC value is also recorded in memory 25 of the system 50 shown in FIG. 1.

At step 106, the navigation system 50 calculates, for each node in the graph (G) having at least one charging point (C), as represented by point 41 in FIG. 2, the range/energy remaining after a charging event is completed. For illustrative purposes, a conventional route based on distance or time is represented by the path of arrows 40. The EV range at origin (O) is indicated by circle 30. Thus, the route indicated by arrows 40, while the most optimal in terms of distance or travel time using conventional algorithms, would strand the user, or would require use of fuel energy to extended the EV range in the case of an EREV.

At step 108, the navigation system 50 determines whether the vehicle 10 can reach the destination (point D) in EV mode. If so, step 110 is executed. If not, step 112 is executed.

At step 110, the navigation system 50 of FIG. 1 generates the recommended EV travel route using any suitable criteria, e.g., the closest distance or shortest travel time, as indicated by arrows 40.

At step 112, the navigation system 50 of FIG. 1 generates the recommended EV travel route 140 in a manner which passes through the charging waypoint 41, or more such waypoints as needed, without respect to any optimal distance or travel time routing algorithms which would tend to direct the vehicle 10 along a much different route, such as the route indicated by arrows 40.

A new map is thus generated with knowledge of all prior charging event(s) in memory, with previously searched nodes and additional newly searched nodes displayed as map information. In this manner a new map is associated with each charging waypoint, and the sequence of maps changes depending on how a user travels through the road network with respect to the charging stations.

That is, the navigation system 50 keeps track of all prior charging/refueling events and modifies the travel route as needed with each event. The loop of steps 106, 108, and 112 in FIG. 3 can then continue as many times as needed, with the same number of corresponding map layers, to always direct the vehicle 10 to a charging waypoint when needed, or the destination point (D) when charging is no longer required. If the system 50 can find a route to the destination (D), it does so regardless of whether a charging waypoint exists along the route.

Referring to FIG. 4, an example method 200 is shown for determining the opportunity cost of moving through a given road network, and thus implementing method 100 described above. Variables are defined as follows, with the actual shorthand used to define a given variable being a programming preference and thus subject to variation:

geo_{GOAL}=physical location of the goal for the route;

START=the location of the starting point and an empty list which represents available charging stations in a road network;

C, F=empty sets;

O=a set containing START;

c_{SCORE}, g_{SCORE}, h_{SCORE}, f_{SCORE}=mappings from a corresponding geographic location and a list of charging locations to a real number;

At step 202, c_{SCORE}[START] is set equal to 0, as is g_{SCORE}[START]. h_{SCORE} is a heuristic estimate of the distance or cost to arrive at the location geo_{GOAL}. Additionally, f_{SCORE}[START] is set equal to h_{SCORE}[START]. Let came from be a mapping from a geographic location and list of charging locations to another geographic location and list of charging locations. Once all variables have been set in this manner, the method 200 proceeds to step 204.

At step 204, the system 50 of FIG. 1 determines if the set O is empty. If so, the method 200 proceeds to step 206. Otherwise, the method 200 proceeds to step 208.

At step 206, the system 50 returns an indication that no path exists.

At step 208, a variable x is defined as the element in which set O minimizes the function f_{SCORE}[X].

At step 210, the system 50 determines if the geographic location of (x) is the same as that of geo_{GOAL}. If so, the method 100 proceeds to step 212. Otherwise, the method 100 proceeds to step 214.

At step 212, the system 50 returns a path from (x) to the start using came_from (see step 202) to construct the path.

At step 214, the system 50 removes (x) from set O, and adds (x) to set C, then proceeds to step 216.

At step 216, N is established as the set of neighbor nodes in the network which can be reached from (x) given the value of c_{SCORE}(x). After N is established, the method 200 proceeds to step 218.

At step 218, the system 50 of FIG. 1 determines if the set N is empty. If so, step 204 is repeated. If not, the method 100 proceeds to step 220.

At step 220, an element (y) of set N is removed from set N.

At step 222, the system 50 determines if (y) is in set C. If so, step 218 is repeated. If not, the method 200 proceeds to step 224.

At step 224, the system sets a variable tentative g_{SCORE} equal to g_{SCORE}(x) plus the cost of travel from (x) to (y) plus a cost of charging, if charging is needed.

At step 226, the system 50 determines if (y) is in set O. If so, the method 100 proceeds to step 228. Otherwise, step 218 is repeated.

At step 228, (y) is added to set O. The method 100 then proceeds to step 232.

At step 230, the system 50 of FIG. 1 determines if tentative g_{SCORE} is less than g_{SCORE}(y). If it is, the method 100 proceeds to step 232, and otherwise repeats step 218.

At step 232, the value of came from (y) is set equal to (x). The method 100 then proceeds to step 234.

At step 234, the value of g_{SCORE}(y) is set equal to tentative g_{SCORE}. h_{SCORE} is set as a heuristic estimate of the cost of travel from (y) to the goal, and f_{SCORE}(y) is set equal to the sum of g_{SCORE}(y) and h_{SCORE}(y).

At step 236, the system 50 determines if the transition from (x) to (y) involved charging. If so, the method 200 proceeds to step 238. Otherwise, the method 200 proceeds to step 240.

At step 238, c_{SCORE}(y) is set to 0, and the method 200 repeats step 218.

At step 240, the value of c_{SCORE}(y) is set to the sum of the cost of traveling from (x) to (y) and the value of c_{COST}(x). The method 200 then repeats step 218

Referring to FIG. 5, an example method 300 is shown for identifying neighbor nodes in a road network. At step 302, the variable x is set as a geographic location and list of previous charging locations. c_{SCORE} is set as the mapping from points like those in (x) to a real number. S is initially an empty set. Chargeᵣ is the history of all charging locations for the vehicle during a trip up to and including the present geographic location (geoₓ). A is a set of all points which are physically connected to geoₓ.

At step 304, the system 50 of FIG. 1 determines if A is an empty set. If so, the method 300 proceeds to step 314. Otherwise, the method 300 proceeds to step 306.

At step 306, an element (y) in set A is removed from A, and the method 300 proceeds to step 308.

At step 308, the system 50 determines if c_{SCORE}(x) plus the cost of traveling from the location of (x) to the location of (y) is less than a range threshold. If so, the method 300 proceeds to step 310. Otherwise, the method 300 repeats step 304.

At step 310, a variable full_y is set as the combination of the physical location of (y) and the history of charging prior to arriving at (y).

At step 312, full_y is added to set N, and the method 300 repeats step 304.

At step 314, the system 50 of FIG. 1 determines if charging can occur at the location of (x). If so, the method 300 proceeds to step 316. Otherwise, the method 300 repeats step 304.

At step 316, a variable new_charging_history includes the history of charging locations, with the location of (x) added to the list at this step.

At step 318, new_y is set as the combination of the location of (x) and new_charging_history (see step 316).

At step 320, the system 50 adds new_y to set N, and proceeds to step 322.

At step 322, the system 50 returns set N, which can be displayed as nodes on the route.

While the method described above can generate the routes, such a method can be improved on by only searching a portion of the map for feasible routes which satisfy range requirements between charge events. Such a method can be created starting from an algorithm like the A* algorithm which is commonly used to find the shortest path between two locations. As understood in the art, A* uses a best-first search and finds the least-cost path from a given initial node to one goal node out of one or more possible goals. A* does uses a distance-plus-cost heuristic function, ƒ(x), to determine the order in which the search visits nodes. The distance-plus-cost heuristic is a sum the path-cost function, i.e., the cost from the starting node to the current node g(x), and a “heuristic estimate” of the distance to the goal, h(x).

In modifying the A* algorithm, each point in the graph and travel represents not only the physical location of the node, but also the history of charging locations which preceded arrival at that particular node. Furthermore, because charging incurs a cost, some positive cost is assigned to each charging event when calculating the route. An illustrative flowchart for calculation of the route is shown in FIG. 4 and described below.

A further complication in route generation for a problem like this is determining when a neighboring node, which is physically connected, cannot be reached because of a restriction like range or energy. This problem is solved by tracking the amount of range or energy which is consumed since the last charging event and using this information when selecting neighbors where travel can be happen. A flow chart for accomplishing this is illustrated in FIG. 5.

Existing routing algorithms and databases may be reused to automatically insert charging waypoints as needed by modifying the representation of vertices (V) in the digraph to represent the physical location of the vehicle 10, plus the sequence of charging events which have occurred along the recommended travel route. A calculation is added for each evaluated node, wherein the remaining range of the vehicle 10 is determined. The navigation system 50 can restrict the next point considered to only include points which can be reached based on the initial range and charging stops. In this manner, range anxiety can be eliminated relative to conventional methods such as searching for a charging station along a best distance/best time travel route, or within a calibrated range thereof.

While the best modes for carrying out the invention have been described in detail, those familiar with the art to which this invention relates will recognize various alternative designs and embodiments for practicing the invention within the scope of the appended claims.

1. A navigation system for a vehicle having a battery and a traction motor which propels the vehicle using electrical energy from the battery, the navigation system comprising:
a display device;
a host machine in communication with a map database containing information describing a geocoded road network, wherein the road network includes a plurality of nodes each describing a point within the road network, and wherein at least some of the nodes describe charging waypoints, wherein the host machine is configured for:
recording a trip destination;
determining a remaining state of charge (SOC) of the battery;
calculating, for every node of the plurality of nodes, a remaining electric vehicle (EV) range of the vehicle using the remaining SOC;
generating a first recommended EV travel route to the destination using one of a shortest distance and a shortest travel time approach when the destination lies within the remaining EV range from a node describing the present location of the vehicle;
generating a second recommended EV travel route to the destination through at least one of the charging waypoints where the battery may be recharged when the destination lies outside of the remaining EV range; and
displaying one of the first and second recommended EV travel routes via the display device.

2. The system of claim 1, wherein the host machine is configured for generating the second recommended EV travel route by restricting a list of next-considered nodes of the plurality of nodes to only include nodes that can be reached by the vehicle based on the remaining SOC and any from any charging waypoints located within the remaining EV range.

3. The system of claim 2, wherein the host machine executes an A* algorithm to search the list of next-considered nodes.

4. The system of claim 1, wherein the host machine is configured to modify the second recommended EV travel route using the remaining EV range calculated for each charging waypoint.

5. The system of claim 1, wherein the host machine is configured to record a sequence of charging events as the vehicle travels to the destination, and for updating the list of next-available nodes in response to completed charging events.

6. A vehicle comprising:
a battery;
a traction motor configured for electrically propelling the vehicle using energy from the battery; and
a navigation system for a vehicle having a traction motor, the navigation system including:
a display device; and
a host machine in communication with a map database containing information describing a geocoded road network, wherein the road network includes a plurality of nodes each describing a point within the road network, and wherein at least some of the nodes describe charging waypoints where the battery may be recharged, wherein the host machine is configured for:
recording a trip destination;
determining a remaining state of charge (SOC) of the battery;
calculating a remaining electric vehicle (EV) range of the vehicle using the remaining SOC for every node of the plurality of nodes;
generating a first recommended electric-only (EV) travel route to the destination using one of a shortest distance and a shortest travel time approach when the destination lies within the remaining EV range from a node describing the present location of the vehicle;
generating a second recommended EV travel route to the destination through at least one of the charging waypoints when the destination lies outside of the remaining EV range; and
displaying one of the first and second recommended EV travel routes via the display device.

7. The vehicle of claim 6, wherein the host machine is configured for generating the second recommended EV travel route by restricting a list of next-considered nodes of the plurality of nodes to only include nodes that can be reached by the vehicle based on its current SOC and any from any charging waypoints located within the remaining EV range.

8. The vehicle of claim 7, wherein the host machine executes an A* algorithm to search the list of next-considered nodes.

9. The vehicle of claim 6, wherein the host machine is configured to modify the second recommended EV travel route using the remaining EV range calculated for each charging waypoint.

10. The vehicle of claim 6, wherein the host machine is configured to record a sequence of charging events as the vehicle travels to the destination, and for updating the list of next-available nodes in response to completed charging events.

11. A method for using a navigation system in a vehicle having a battery and a traction motor for electrically propelling the vehicle using energy from the battery, the method comprising:
receiving a trip destination using a display device of the system;
recording the trip destination using a host machine in communication with the display device;
determining a remaining state of charge (SOC) of the battery using the host machine, wherein the host machine is in communication with a map database containing information describing a geocoded road network having a plurality of nodes each describing a point within the road network, and wherein at least some of the nodes describe charging waypoints;
calculating a remaining electric vehicle (EV) range of the vehicle as a function of the remaining SOC for every node of the plurality of nodes;
generating a first recommended electric-only (EV) travel route to the destination using one of a shortest distance and a shortest travel time approach when the destination lies within the remaining EV range from a node describing the present location of the vehicle;
generating a second recommended EV travel route to the destination through at least one of the charging waypoints when the destination lies outside of the remaining EV range; and
displaying one of the first and second recommended EV travel routes via the display device.

12. The method of claim 11, wherein generating the second recommended EV travel route includes restricting a list of next-considered nodes of the plurality of nodes to only include those nodes that can be reached by the vehicle based on its current SOC and any from any charging waypoints located within the remaining EV range.

13. The method of claim 12, further comprising using an A* algorithm to search the list of next-considered nodes.

14. The method of claim 11, further comprising modifying the second recommended EV travel route using the remaining EV range calculated for each charging waypoint.

15. The method of claim 11, further comprising: recording a sequence of charging events as the vehicle travels to the destination, and for updating the list of next-available nodes in response to completed charging events.
